(19) United States
(12) Patent Application Publication
(10) Pub. No.: US 2013/0087277 A1
(43) Pub. Date: Apr. 11, 2013

(54) METHOD FOR BONDING CONDUCTIVE MATERIAL

(71) Applicants: Shih-Chin Chang, Hsinchu City (TW); Ping-Cheng Sung, Hsinchu City (TW)

(72) Inventors: Shih-Chin Chang, Hsinchu City (TW); Ping-Cheng Sung, Hsinchu City (TW)

(73) Assignee: NATIONAL TSING HUA UNIVERSITY

(21) Appl. No.: 13/344,632

(22) Filed: Jan. 6, 2012

(30) Foreign Application Priority Data
Oct. 7, 2011 (TW) 100136441

(51) Int. Cl. B29C 65/36

(52) U.S. Cl. 156/273.9

(57) ABSTRACT

A method for bonding conductive materials by using composite adhesive made of carbon nanotubes and epoxy resin. Firstly, this composite adhesive is placed between the joining surfaces of the two conductive plates; thereafter an electric current enters from one conductive plate and passes through this composite adhesive, to the other conductive plate. As the electric current passes through the carbon nanotubes, Joule heating results in the overall temperature of the carbon nanotubes-epoxy composite adhesive increasing, leading to speedily joining and patching of the composite adhesive. This method reduces the electrical resistance of the adhesive material by providing a large area and shortening the path of the electric current, also, improving the homogeneity of the temperature of the adhesive and avoiding the positive feedback effect. The simple equipment of this method is not affected by the environment, and effectively reduces the resources and time needed to harden the epoxy resin.

### BACKGROUND OF THE INVENTION

1. Field of the Invention

The present invention relates to a method of bonding conductive material by using a carbon nanotubes-epoxy composite adhesive, in particular to a method whereby Joule heating of the carbon nanotubes is used to heat and cure the carbon nanotubes-epoxy composite adhesive.

2. Description of the Related Art

Epoxy resin is a composite resin with wide applications, possessing good adhesive characteristics, electrical insulation, and at the same time can obtain different mechanical properties depending on the differences of the added filling agent and hardening agent, and with wide applications in all trades and industries. Presently the main domestic applied field of epoxy resin is in the substrate material of Printed Circuit Boards, which require upwards of 60% of total epoxy resin, other uses are in applications in related electrical and semiconductor fields. There are also applications as conductive/joining material, sealing material, and in liquid photosensitive green paints, and applications in sealing LCD monitors. Demand is already wide in scope and is rapidly growing, with lots of space for development.

Currently the applied fields of epoxy resin for producers are from adhesives, paints, sealant material, filler, coatings and so on, and can extend to applications as an electrical filling agent, composite materials in wind powered generators, nano materials and construction material and so on.

Compared to mechanical rivets for fixing and mending, epoxy resin already has wide applications in industry for fixing and mending, the production process of using epoxy resin to join items is simple, with less stress concentration, with no liquid penetration at the joins, or rust corrosion and so on. The hardening of high strength epoxy resin requires a high temperature environment to proceed.

Traditional heating and hardening methods which are used include heated boards, heated blankets, infrared lights or high temperature ovens. However these methods of heating rely on external parts to transmit or radiate the heat to the adhesive layer to cure it. Therefore requiring a longer hardening time, and causing a lot of the heat energy to disperse and be wasted.

An epoxy resin body with a copper mesh distributed inside was developed, and electromagnetic induction was used to electrically heat up the copper mesh, thus allowing the epoxy resin to be heated and cured. This method can greatly reduce the hardening time, but the diameter of the copper wire in the copper meshing is restricted to 150 microns (currently the diameter of copper wire is at least tens of microns), but there's no way to reduce it to nano class, and therefore the bond with the epoxy resin is not satisfactory, and when force is concentrated the bond is easily broken, thus weakening the strength of the bond.

Previously microwaves have been used to heat the carbon nanotubes-epoxy resin composite adhesive, and although this process greatly reduces the heating and strengthening time, and increases the strength of the bond, the method of heating and hardening with microwaves has several limitations. For example, the microwave equipment required is costly, complicated, and the area treated is restricted to the area that the microwaves can stably project onto. Also, because this bonding method uses microwaves for heating, it can't be used on substrates which don't absorb microwaves, and is not suitable for bonding metallic materials.

Carbon nanotubes are conductive and can be heated by applying an electric current. When the amount of carbon nanotubes added in a carbon nanotube/epoxy resin composite material exceeds a percolation threshold, the carbon nanotubes-epoxy composite adhesive becomes conductive and can be rapidly heated by allowing electric current to pass through it. However, the conductivity of carbon nanotubes possesses some of the same characteristics as semiconductors. That is, their resistance decreases with an increase of temperature. So, when heated by electric current, if a part of the carbon nanotubes-epoxy composite adhesive is heated more than the other parts, then more current will be concentrated in this part which in turn will generate more heat. This conductivity-temperature positive feedback effect will cause the final burn-out of the carbon nanotubes-epoxy composite adhesive along a narrow path. Therefore, it is not feasible to cure the carbon nanotubes-epoxy composite adhesive layer by applying electric current through leads from two edges of the layer as in the usual way.

To overcome the difficulty of the positive feedback effect mentioned above, the applicant has invented a method of using carbon nanotube bulkypaper to heat the carbon nanotube/epoxy composite adhesive and filed a patent application. In the research process, the applicant noticed that when bonding conductive materials, one can save the carbon nanotube bulkypaper and simply use conductive materials as the electrodes to get the current flow from one surface of the adhesive film to the other surface. By this new invented process, it is proved that the problematic positive feedback effect can be largely reduced or totally eliminated. The epoxy resin adhesive film can be heated evenly and the curing time largely reduced due to the short distance/large area current flow path and the effective heat spreading capability of the conducting materials.

### SUMMARY OF THE INVENTION

The purpose of the present invention is to provide a method for bonding conductive material, wherein each conductive substrate is treated as an electrode, utilizing the conductive properties of carbon nanotubes, so as to form a carbon nanotubes-epoxy composite adhesive by adding carbon nanotubes into epoxy resin adhesive materials, and when the addition of carbon nanotubes exceeds a percolation threshold, the carbon nanotubes-epoxy composite adhesive has nearly corresponding conductivity,

In order to achieve the above mentioned purpose, the present invention provides a method for bonding conductive material, including the following steps: (a) producing a carbon nanotubes-epoxy composite adhesive; (b) coating the joining surface of a first conductive material and a second conductive material with the carbon nanotubes-epoxy composite adhesive; and (c) Applying electric current from the first conductive material through the composite adhesive to the second conductive material, wherein the content of carbon nanotubes occupies a percentage by weight of 0.5˜6 wt % of the total weight of the carbon nanotubes-epoxy composite adhesive.

Preferably, the carbon nanotubes-epoxy composite adhesive in step (a) is a high-temperature solidification type epoxy resin with hardener added.

Preferably, the electric current in step (c) is adjusted according to the curing temperature of the used epoxy resin composite adhesive and the size of the joining area of the first conductive material and the second conductive material.

Therefore, the method of the present invention provides a novel bonding method, utilizing the carbon nanotubes-epoxy composite adhesive to bond the conductors. In the technique of this invention, the conductors are used as the guiding path for the electric current, which uniformly disperse high temperature and allow the electric current to pass through the carbon nanotubes-epoxy composite adhesive and generate heat energy, so as to harden the epoxy resin and achieve the purpose of bonding two conductors.

The adhesive bonding by curing of the carbon nanotubes-epoxy composite adhesive, and through direct application of electric current process of this invention is very time and energy saving, and the adhesion can be completed by simple equipment and the method is free from the impact of the environment. Furthermore, the method of this technology is not limited by the volume size of the articles to be bonded, as compared with conventional bonding methods, and this invention is more convenient and efficient, having a high value for industrial use, and meeting the requirements of the market and commercial applications.

The invention, as well as its many advantages, may be further understood by the following detailed description and drawings in which:

### BRIEF DESCRIPTION OF THE DRAWINGS

FIG. 1 is a production flow chart showing one embodiment of the present invention.

FIG. 2 is a side view showing one embodiment of the invention.

### DETAILED DESCRIPTION OF THE INVENTION

The technical characteristics and operation processes of the present invention will become apparent with the detailed description of preferred embodiments and the illustration of related drawings as follows.

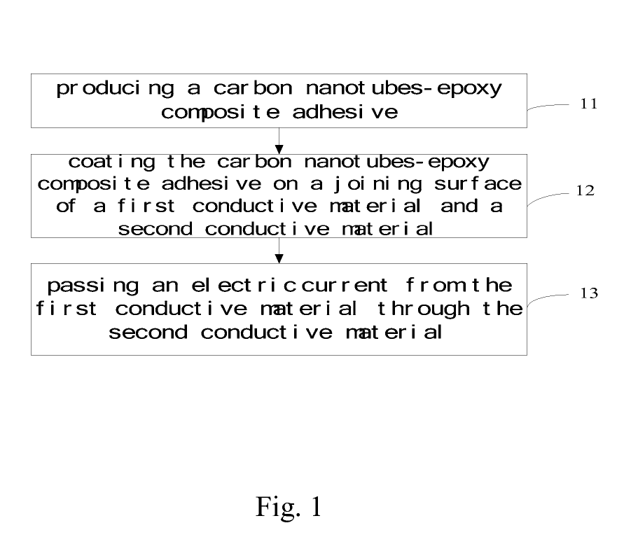

Please refer to FIG. 1, which is a production flow chart showing one embodiment of the present invention. First of all, producing a carbon nanotubes-epoxy composite adhesive 11, and the composite adhesive is a high-temperature solidification type epoxy resin with hardener added. In this embodiment, the content of carbon nanotubes occupies a percentage by weight of 0.5˜6 wt % of the total weight of the carbon nanotubes-epoxy composite adhesive, allowing the composite adhesive to be conductive, then coating the joining surface of a first conductive material and a second conductive material 12 with the carbon nanotubes-epoxy composite adhesive, thereafter, passing an electric current from the first conductive material through the carbon nanotubes-epoxy composite adhesive to the second conductive material 13, wherein the electric current is adjusted according to the volume of the first conductive material and the second conductive material and Joule heating is used for heating and curing, and where the curing temperature is varied according to the epoxy resin material used, and the curing time is less than 20 minutes.

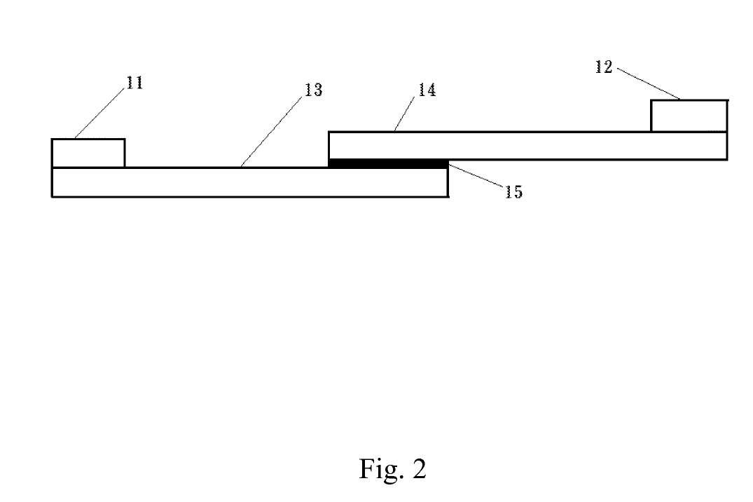

Please refer to FIG. 2, which is a side view showing one embodiment of the invention. As shown in the figure, two electrodes 21 and 22 are set on two conductive materials 23 and 24 respectively, and a carbon nanotubes-epoxy composite adhesive 25 is coated on the junction of the two conductive materials 23 and 24, and when the electric current for heating passes through, the current flows from the electrode 21, through the conductive material 23, through the carbon nanotubes-epoxy composite adhesive 25, and then to the conductive material 24, and finally connects to the electrode 22, and vice versa. Subsequently, the carbon nanotubes-epoxy composite adhesive 25 is integrally heated by the electric current, that is, the two conductive materials 23 and 24 can be completely bonded after the curing temperature is reached.

In summary, the carbon nanotubes-epoxy composite adhesive is produced with a complex epoxy resin containing 0.5 wt % or more of carbon nanotubes. Since the carbon nanotubes are good electric conductors, when the weight percentage of the carbon nanotubes in the epoxy resin goes over a percolation threshold, this enables the composite adhesive to also be conductive.

And then the electric current flows through the conductors, and then passes through the carbon nanotubes to elevate the temperature, thus enabling the heat to be uniformly distributed in the epoxy resin. The conductors can disperse the heat uniformly, and the composite adhesive material is not easily destroyed, whilst the epoxy resin can be uniformly heated and hardened, thereby achieving the purpose of rapid bonding and the effect of fixing and mending the composite material.

The time and energy consumption of the adhesion method of the present invention is less than those of any other conventional techniques, and experiments confirm that the purpose of bonding can be realized by simple equipment.

In addition, the method of this technology is not limited by the volume of the article to be bonded. Compared with conventional bonding methods, this invention is more convenient and efficient, meeting the requirements of the market and commercial applications.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A method for bonding conductive material, comprising the following steps:
(a) producing a carbon nanotubes-epoxy composite adhesive;
(b) coating the carbon nanotubes-epoxy composite adhesive on a joining surface of a first conductive material and a second conductive material; and
(c) passing an electric current from the first conductive material to the second conductive material,
wherein the content of carbon nanotubes occupies a percentage by weight of 0.5˜6 wt % of the total weight of the carbon nanotubes-epoxy composite adhesive.

2. The method of claim 1, wherein the carbon nanotubes-epoxy composite adhesive in step (a) is a high-temperature solidification type epoxy resin with hardener added.

3. The method of claim 1, wherein the electric current in step (c) is adjusted according to a curing temperature of a epoxy resin composite adhesive used, and a joining area of the first conductive material and the second conductive material.
